(19) United States
(12) Patent Application Publication
(10) Pub. No.: US 2012/0290724 A1
(43) Pub. Date: Nov. 15, 2012

(54) SYSTEM AND METHOD FOR NETWORK REDIRECTION

(75) Inventors: Raffaele Noro, Encino, CA (US); Vadim Olshansky, Tarzana, CA (US); Michael Keaney, Oak Park, CA (US)

(73) Assignee: Nomadix, Inc., Agoura Hills, CA (US)

(21) Appl. No.: 13/460,997

(22) Filed: May 1, 2012

Related U.S. Application Data
(60) Provisional application No. 61/484,155, filed on May 9, 2011.

(51) Int. Cl. G06F 15/173

(52) U.S. Cl. 709/225

(57) ABSTRACT

One embodiment of the present disclosure provides a system for identifying and directing requests for network services. During operation, the system receives at a network controller a Domain Name System (DNS) query from a client device. The system can determine if the DNS query includes a pre-defined DNS string. Further, if the DNS query includes the pre-defined DNS string, the system identifies a local portal associated with the pre-defined DNS string. Moreover, the system can direct the client device to the local portal.

### CROSS-REFERENCE TO RELATED APPLICATIONS

This application claims priority as a non-provisional application to U.S. Prov. Pat. App. No. 61/484,155, filed May 9, 2011, which is hereby incorporated by reference as if set forth herein in its entirety.

### BACKGROUND

It has become relatively common for organizations to provide Internet access to users. In some cases, an organization may wish to control the extent of a user's Internet access. For example, the organization may wish to restrict Internet access to paying customers. Further, in some cases, the organization may wish to provide a value-added service tied to the user's network access. For example, assuming the organization is a hotel, the hotel may wish to present the user with fast and reliable access to the user's bill or to present the user with a list of options associated with services provided by the hotel, such as room service, movie rental, or ticket purchase for local attractions.

In addition to providing a user with Internet access and value-added services, the organization typically desires to not interfere with access to the Internet. Thus, it is desirable that the organization can accurately identify when a user is attempting to access an external network, such as the Internet, and when the user is attempting to access the organization's internal network or services.

### SUMMARY

One embodiment of the present disclosure provides a system for identifying and directing requests for network services. During operation, the system receives at a network controller a Domain Name System (DNS) query from a client device. The system can determine if the DNS query includes a pre-defined DNS string. Further, if the DNS query includes the pre-defined DNS string, the system identifies a local portal associated with the pre-defined DNS string. Moreover, the system can direct the client device to the local portal.

In a variation, directing the client device to the local portal further comprises the system directing the client device to a portal page on the local portal.

In a further variation, the portal page can comprise information associated with a user of the client device.

In a further variation, the system can identify the portal page from a plurality of portal pages based, at least in part, on one or more of the pre-defined DNS string, a time, and a pre-defined event.

In a variation, the system provides a DNS response to the client device in response to determining that the DNS query includes the pre-defined DNS string, wherein the DNS response comprises an Internet Protocol (IP) address associated with a local network device. Further, the system receives a Hypertext Transfer Protocol (HTTP) request to the IP address, wherein the HTTP request includes the pre-defined DNS string. In response to receiving the HTTP request, the system can direct the client device to the local portal.

In a further variation, the DNS response further comprises a time-to-live value.

In a variation, directing the client device to the local portal further comprises the system providing one or more direction parameters to the local portal.

In a further variation, the one or more direction parameters can be associated with one or more of the following: the client device, a user of the client device, a second user associated with the user of the client device, and the local portal.

In a further variation, the system can access the one or more direction parameters from one or more of a data repository, the client device, a user of the client device, and the local portal.

### BRIEF DESCRIPTION OF THE DRAWINGS

Throughout the drawings, reference numbers are re-used to indicate correspondence between referenced elements. The drawings are provided to illustrate example embodiments described herein and not to limit the scope thereof.

FIG. 1 illustrates an example embodiment of the Destination HTTP Redirection in accordance with this disclosure.

FIG. 2A illustrates one embodiment of a computing environment with a network gateway.

FIG. 2B illustrates one embodiment of a computing environment with a network gateway.

FIG. 3 illustrates an embodiment of an environment with a network gateway that includes a local portal.

FIG. 4 presents a flow diagram for an example of a network destination redirection process.

FIG. 5 is an embodiment of a web browser with a predefined string entered.

FIG. 6 is an embodiment of a web browser displaying a local portal page.

### DETAILED DESCRIPTION

### Overview

The present disclosure relates to a system for DNS-triggered redirection of HTTP requests to one or more portal page URLs configured on a network gateway.

In one example usage scenario, the Destination HTTP Redirection will enable subscribers or users of network services, such as a High Speed Internet Access (HSIA) service provided by a hotel or other provider, to access their account status and activity in a fast and reliable fashion through any network gateway. To access their account, subscribers can point their browser to a website specified by the network gateway administrator.

Features of the present disclosure can provide the configuration means and the internal mechanisms for responding to website requests that match configured DNS names.

In one embodiment, the network gateway is capable of intercepting and responding to DNS queries containing configurable strings. Subscribers requesting a website at the specified DNS will obtain a DNS response that contains a “magic” IP address. The “magic” IP address is the IP address that is used to access and reference the network gateway and control functions associated with the network gateway. For example, it is the value obtained when the subscriber queries the DNS string “logout.<network_gateway>.com”. In one embodiment, this “magic” IP address differs from an IP address reserved for administrator access. In an alternate embodiment, the “magic” IP address is the same as the IP address reserved for administrator access. The “magic” IP address may be previously associated with a network device such as the network gateway, or it may be not associated with any network device, in which case the network gateway may be configured to identify and respond to requests directed to this and/or other unassociated IP addresses. In an embodiment, more than one “magic” IP address may be returned, possibly depending on the content of the DNS request and/or other factors.

The network gateway can process HTTP requests for the “magic” IP address, and will reply with an HTTP redirection to a configured portal page URL that can include an arbitrary number of redirection parameters, whether signed or not. In an embodiment, a “signed” URL includes a cryptographic or digital signature, a checksum, or another identifier, configured to ensure that other parameters of the URL are not modified. By following the HTTP redirection, the subscriber will reach the portal page and he/she will be served a page containing the relevant information about his/her account or any other information associated with the subscriber and the portal page.

In one embodiment, the “magic” IP address is a configurable parameter. Further, in one embodiment, the name of the parameter can also be configurable. Additionally, some user computers are configured, by DHCP or otherwise, to append various suffixes to domain names, so in an embodiment, the network gateway or other device may be configured to accept parameters with a variety of suffixes. For example, a user computer may be configured to automatically append “.example.com” to the end of domain names. Thus, the network gateway may be configured to respond with the “magic” IP address to requests for “mydetails,” “mydetails.<hotel_brand>.com,” “mydetails.example.com,” and the like. The particular combination of domain names may be configurable or predefined.

In one embodiment, the network gateway subscribers can be in a pending or a valid authentication state. The Destination HTTP Redirection will redirect subscribers in both pending and valid authentication states.

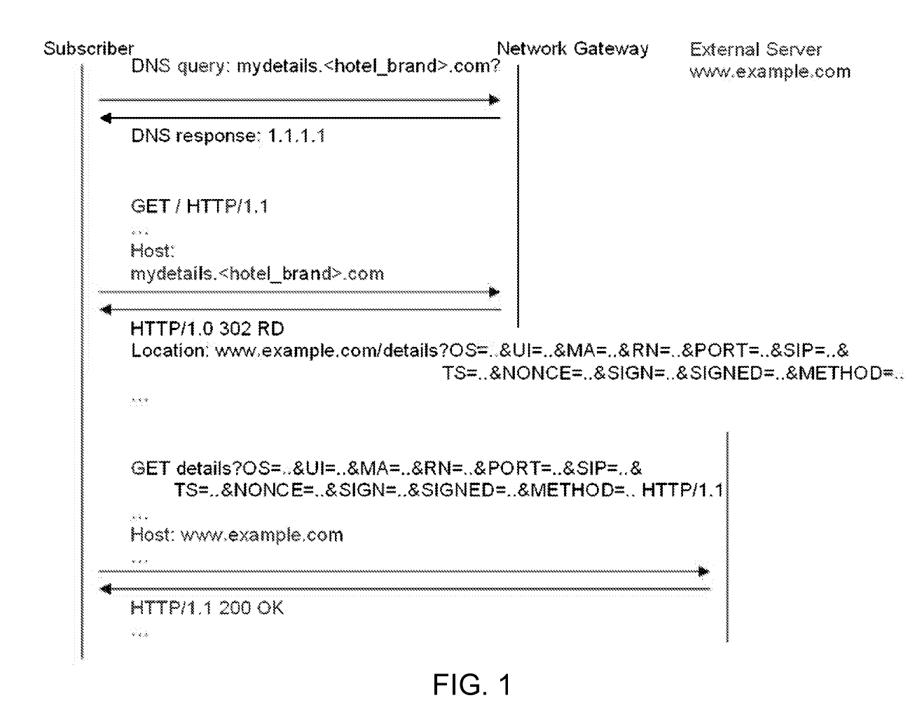

FIG. 1 illustrates an example embodiment of the Destination HTTP Redirection, assuming a DNS query string for “mydetails.<hotel_brand>.com”, a “magic” IP address of 1.1.1.1, and a portal page URL of “www.example.com/details”.

In this example embodiment, the DNS query for “mydetails.<hotel_brand>.com” is received by the network gateway, which responds with the “magic” IP address. Then, the subscriber's browser sends an HTTP request to the “magic” IP and sets the Host header to “mydetails.<hotel_brand>.com”.

The network gateway will process the HTTP request, and will analyze the Host header to find the redirection URL that corresponds to “mydetails.<hotel_brand>.com”, which is “www.example.com/details” in this example. After that, the network gateway will craft an HTTP redirection response that contains the portal page URL followed by a query string with various redirection parameters, time-stamped and signed.

The subscriber will follow the redirection string and will land on the portal page URL. The portal will verify and analyze the query string and will return the information about the subscriber's account status.

In one embodiment, the network gateway administrator can configure the portal page URL(s).

In one embodiment, a DNS query from the subscriber is received and reviewed by the network gateway. In this embodiment, if the Destination HTTP Redirection is disabled, then the network gateway does not further analyze the DNS query. However, if Destination HTTP Redirection is enabled, the network gateway determines if any DNS strings, or keywords have been pre-defined, such as by an administrator. If not, then the network gateway does not further analyze the DNS query. If DNS strings have been predefined, the network gateway determines if the DNS query includes a string that exactly matches one of the predefined DNS strings. If so, the network gateway responds to the DNS query by providing a “magic” IP address. If not, the network gateway forwards the DNS query to a DNS server, which can analyze and respond to the DNS query.

In one embodiment, the value of the “magic” IP address can be configured by an administrator.

In one embodiment, the network gateway can process requests to the “magic” IP address. In this embodiment, if the Destination HTTP Redirection is disabled, the network gateway can return an error. If Destination HTTP Redirection is enabled, the network gateway determines if any DNS strings, or keywords have been predefined, such as by an administrator. If not, the network gateway can return an error. If DNS strings have been predefined, the network gateway determines if the HTTP host header includes a string that matches exactly one of the predefined DNS strings. If so, the network gateway returns a HTTP redirection to the portal page URL associated with the matching string. If not, the network gateway returns an error. In one embodiment, the HTTP Host header value can be associated with a command. For example, the HTTP Host header value “logout.network_gateway.com” can be used to instruct the network gateway to handle a logout request. As a second example, the HTTP Host header value “firmwareupdate.network.gateway.com” can be used to instruct the network gateway to update its firmware.

In one embodiment, the input to the HTTP redirection includes the HTTP Host header from the subscriber and the predefined DNS string(s).

In one embodiment, the HTTP redirection returned by the network gateway can include a number of redirection parameters. Note that these redirection parameters can be associated with one or more of: the subscriber, the portal page, the network gateway, and a computing device associated with the subscriber. For example, the redirection parameters can include: the network gateway ID, the subscriber's MAC address, the subscriber's room name, the subscriber's IP address, a target server ID, or a port value, to name a few.

In one embodiment, the network gateway determines the parameter values automatically. Alternatively, the network gateway determines the parameter values by querying a computing system associated with the subscriber.

In another embodiment, the network gateway may query the subscriber, via a computing device, for the parameter values.

In one embodiment, the subscriber-specific parameters are appended to the HTTP redirection string.

In one embodiment, a signature of the redirection parameters is appended to the HTTP redirection string.

### Example Computing Environments

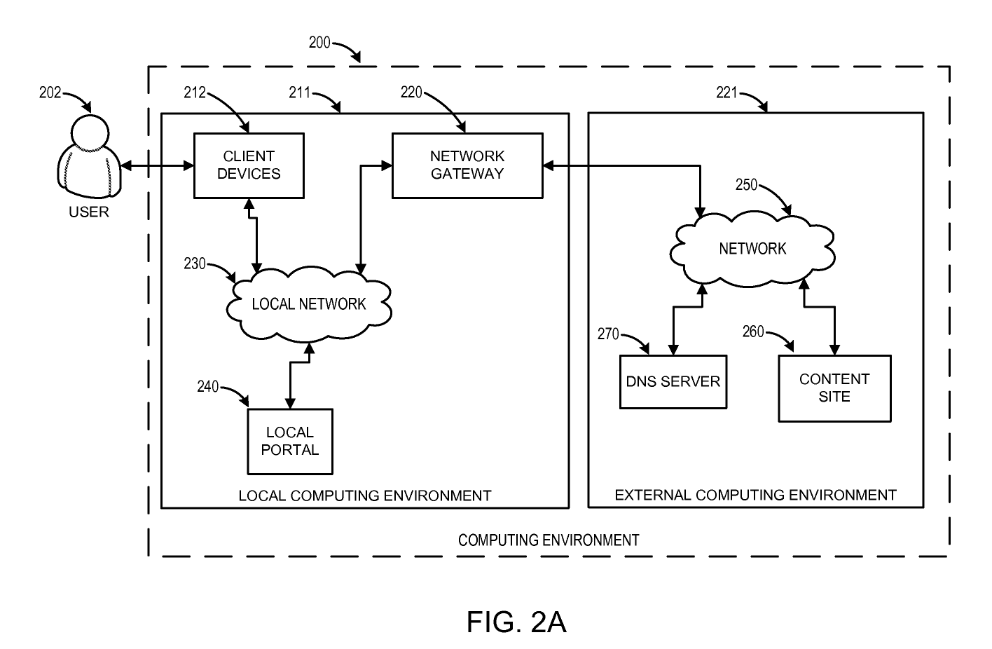

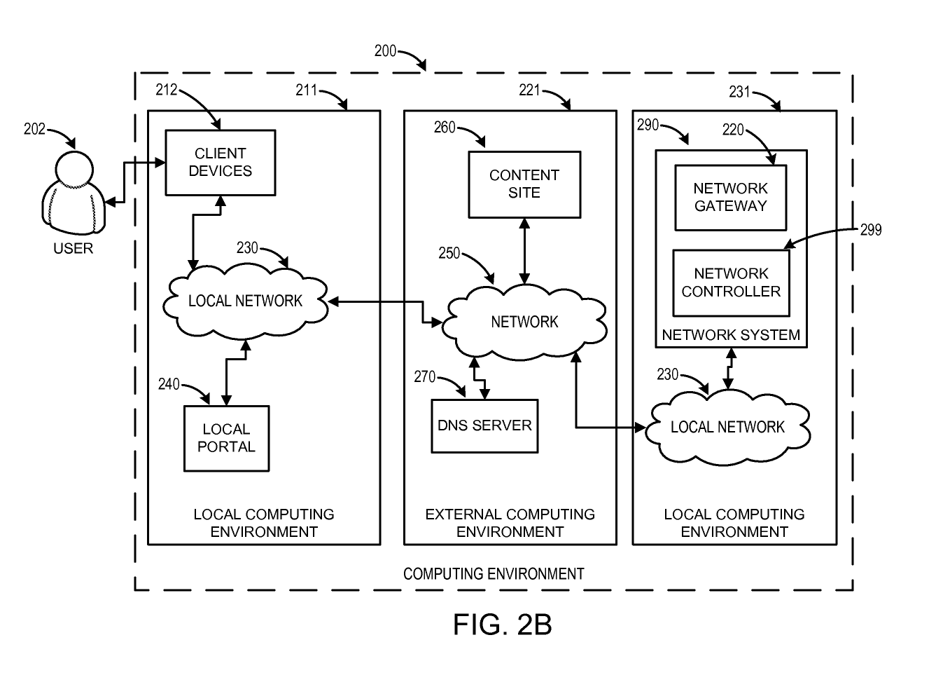

FIG. 2A illustrates one embodiment of a computing environment 200 with a network gateway 220. The example computing environment 200 depicted in FIG. 2A includes a local computing environment 211 and an external computing environment 221. Generally, the local computing environment 211 can include any computing environment associated with an organization. For example, local computing environment 211 can be a computing environment associated with a hotel, an airport, a business, or a home, to name a few. External computing environment 221 can generally include any computing environment external to the local computing environment 211. For example, the external computing environment 221 may represent the Internet.

The local computing environment 211 can include client devices 212, a network gateway 220, a local network 230, and a local portal 240. The external computing environment 221 can include a network 250, a content site 260, and a DNS server 270. In other embodiments, the computing environment 200 may include fewer or additional computing environments. Similarly, in other embodiments, the local computing environment 211 and the external computing environment 221 may include fewer or additional devices and systems. For example, the DNS server 270 can be included as part of the network gateway 220 and/or part of the local computing environment 211. Similarly, the functionality of network gateway 220 can be distributed to several devices split between computing environments.

The client devices 212 are examples of user systems or user devices that can generally include any computing device(s) capable of processing and communicating across a network, such as local network 230 or network 250. For example, the client devices 212 can include a desktop, a laptop, or a wireless handheld device (such as a smart phone, PDA, tablet, or the like), to name a few. In some embodiments, the client devices 212 are devices natively associated with the local computing environment 211. For example, the client devices 212 may be computers in a business center associated with a hotel. In other embodiments, the client devices are devices associated with the user 202 who brings the client devices 212 into the local computing environment 211 for a limited period of time. For example, client devices 212 may be a hotel guest's personal laptop.

The local network 230 and the network 250 may be any type of network including a LAN, a WAN, or a combination of the same. In one embodiment, network 250 can be the Internet.

Generally, the network gateway 220 includes any system that, based on a request received from the client devices 212, either facilitates the client devices 212 accessing external computing environment 221 or directs the client devices 212 to a local portal 240. For example, network gateway 220 can be configured to redirect client devices 212 to local portal 240 in response to a DNS query including a pre-defined keyword. In this same example, network gateway 220 can be configured to allow the client devices 212 to access the content site 260 in response to a DNS query not including a keyword. In one embodiment, the network gateway 220 is an access gateway, which, in some embodiments, can be used to create network and/or Internet HotSpots.

The local portal 240 can generally include any application server, web server, intranet server, database server, or any other computing system that can communicate with client devices 212 over a network. Further, local portal 240 can include any system that can provide client devices 212 with access to a portal page or portal application associated with the local portal 240.

In one embodiment, the local portal 240 is part of the external computing environment 221. In this embodiment, local portal 240 can be a content site associated with the same entity or organization associated with the local computing environment 211. Alternatively, local portal 240 can be associated with a different entity or organization. For example, suppose the local computing environment 211 is associated with a hotel. In this example, the local portal 240 can be a room service ordering system associated with the hotel. Alternatively, the local portal 240 can be a food ordering system associated with a local food delivery organization that may have contracted with the hotel to provide food delivery from local restaurants to the hotel's guests. Although the local portal 240 is depicted as part of local computing environment 211, in some embodiments the local portal 240 can be part of the external computing environment 221.

Content site 260 can generally include any system that is capable of providing a network application, a website, or other web application. Although content site 260 may be affiliated or associated with the same entity that is associated with the local computing environment 211, generally, the content site 260 is independent from said entity. In one embodiment, the content site 260 can be implemented on one or more computing devices, such as physical servers. In an embodiment, the system may include multiple content sites, and a computer may be directed to one of those content sites depending on the DNS string, “magic” IP address, requested content, and/or other data transmitted by the computer.

The DNS server 270 can generally include any system for performing domain name translation. Although depicted as a separate system associated with the external computing environment 221, in some embodiments, the DNS server 270 can be part of the local computing environment 211. Further, in some embodiments, the network gateway 220 can include the DNS server 270.

In one embodiment, the network gateway 220 is configured to send DNS queries to the DNS server 270. Although, as previously described, in some embodiments the network gateway 220 may prevent a subset of DNS queries from reaching the DNS server 270.

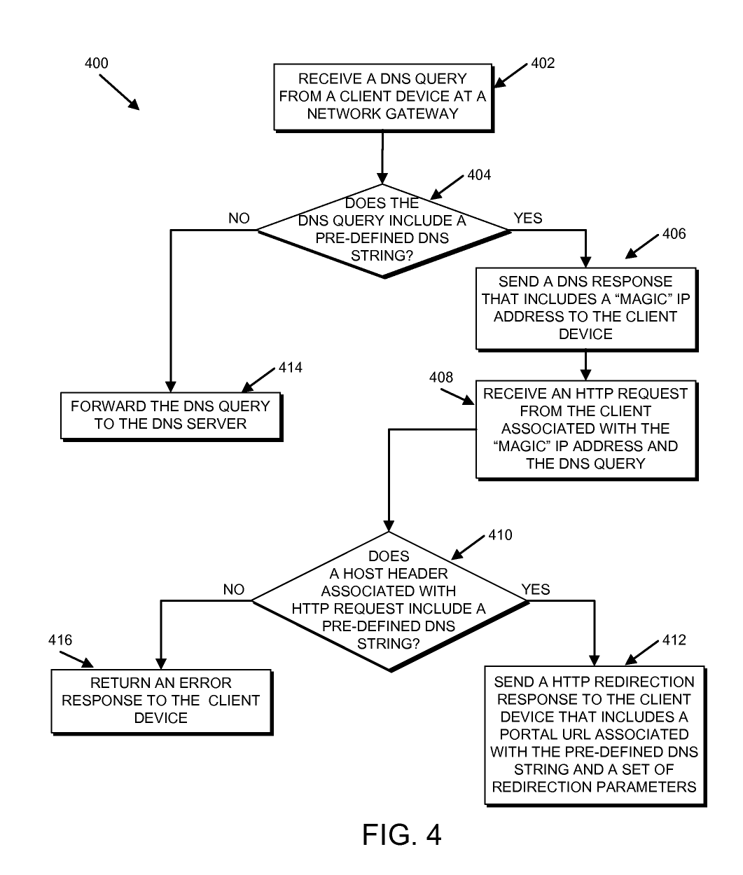

In one embodiment, one or more of the client devices 212 may be statically configured to send DNS queries to the DNS server 270, or to an alternate DNS server (not shown). Such a client device in this situation may be configured to always use a particular DNS server (e.g. the root server 198.41.0.4) or several servers. Alternatively or additionally, one or more of the client devices 212 may be configured to obtain a DNS server address from an alternate source, such as a DHCP server. In these embodiments, the network gateway 220 can be configured to mimic the DNS server 270 or alternate DNS source to facilitate performing the redirection process described below with reference to FIG. 4. For example, the network gateway 220 may be configured to respond to all DNS requests (for example, all UDP requests on port 53) regardless of the intended destination indicated in the requests.

FIG. 2B illustrates a second example of a computing environment 200 with a network gateway 220. In addition to the local computing environment 211 and the external computing environment 221, the example computing environment 200 of FIG. 2B includes the local computing environment 231. The local computing environment 231 can generally include any computing environment associated with the same organization as the local computing environment 211, but which may or may not be located in the same geographic location as the local computing environment 211. For example, the local computing environment 211 and the local computing environment 231 can both be associated with a particular hotel chain, but the local computing environment 211 can be further associated with a specific location and the local computing environment 231 can be further associated with a different specific location of the same hotel chain. As a second example, the local computing environment 211 can be associated with a first location of a hotel chain, and the local computing environment 231 can be associated with a corporate office of the hotel chain located in a different geographical region.

The local network 230 illustrated as part of the local computing environment 211 and the local network 230 illustrated as part of the local computing environment 231 enable computing devices associated with the local computing environments to communicate with each other as well as with computing devices associated with the external computing environment 221. Although each local computing environment is illustrated as including a local network 230, it is possible for the local network 230 of each local computing environment to be the same local network. For example, the local network 230 can include one or more networks associated with the organization that is associated with the local computing environment 211 and the local computing environment 231 as a whole.

One or more of the local computing environment 211, the local computing environment 231, and the external computing environment 221 can include one or more network systems 290. The network system 290 can include any system that can facilitate network-based communication between computing devices. For example, the network system 290 can facilitate the client devices 212 communicating with the content site 260, the local portal 240, or a server (not shown) associated with the local computing environment 231. In some embodiments, the network system 290 can include some or all of the functionality of the network gateway 220 as described with respect to FIG. 2A.

Further, the network system 290 can include one or more additional systems that can facilitate network communication between computing devices. For example, the network system 290 can include the network gateway 220 and the network controller 299 (as illustrated). As a second example, the network system 290 can include the local portal 240 and/or the DNS server 270. Although depicted as part of the local computing environment 231, the network system 290 can be located at the local computing environment 211 or at the external computing environment 221. Further, one or more modules associated with the network system 290 can be distributed across multiple computing environments.

The network controller 299 can generally include any type of network device (e.g. a wired or wireless router, a gateway, a local server, a server on the network 250 or on the cloud) that can facilitate directing or redirecting the client devices 212 to the local portal 240. The network controller 299 can further include some or all of the functionality of the network gateway 220 and/or the DNS server 270. Further, the network controller 299 can be a distributed system. Although the network controller 299 is generally implemented in hardware, in some embodiments, the network controller 299 can be implemented, at least in part, by software.

Example Environment Including a Local Portal with a Network Gateway

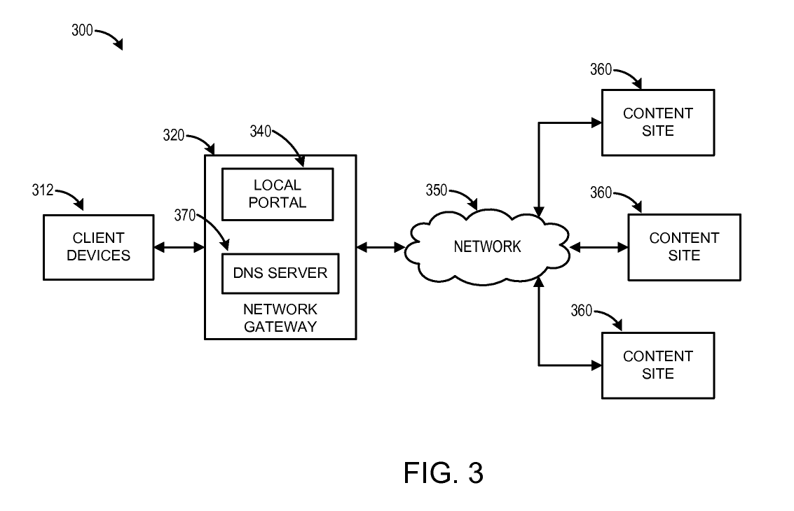

FIG. 3 illustrates an embodiment of an environment 300 with a network gateway 320 that includes a local portal 340. In the illustrated example, the environment 300 includes client devices 312, a network gateway 320, a network 350, and a number of content sites 360. Although depicted identically, the content sites 360 can, for example, each be unique, can represent mirrors of the same content, or can represent cache servers or locations for a particular content provider. Further, the content sites 360 can be associated with one or more organizations that may or may not also be associated with one or more of the additional elements depicted in FIG. 3.

Similar to the client devices 212, the client devices 312 can include any user system or user device that enables a user to access content from one or more content sites 360 and/or from a local portal 340. Further, the network 350 can generally include any type of network including a LAN, a WAN, or a combination of the same that enables computing devices to communicate with each other. In one embodiment, network 350 can be the Internet. Although the client devices 312 are depicted as communicating with the network 350 via the network gateway 320, in some embodiments, the client devices 312 can communicate with the content sites 360 or the network gateway 320 via the network 350.

The network gateway 320 can generally include any system that facilitates communication between the client devices 312 and the network 350 and/or the content sites 360. In the illustrated embodiment, the network gateway includes the DNS server 370 and the local portal 340. Like the DNS server 270, the DNS server 370 can generally include any system for performing domain name translation. Further, the local portal 340 can generally include any system as described with respect to the local portal 240.

Although the local portal 340 and the DNS server 370 are illustrated as part of the network gateway 320, one or both of the local portal 340 and the DNS server 370 can be separate systems. Further, the network gateway 320 can include additional systems, such as a firewall system.

In one embodiment, the network gateway 320, in response to receiving a DNS query from the client devices 312, can determine based on the DNS query whether to provide the client devices 312 with an IP address associated with one of the content sites 360, or with an IP address that is associated with one or more of the network gateway 320 and the local portal 340. In response to receiving a request from the client devices 312 to access the system associated with the IP address, the network gateway 320 can direct the client devices 312 to the content site 360 or to the local portal 340 based on the provided IP address. Thus, for example, if the IP address is associated with the content site 360, the network gateway can direct the client devices 312 to the content site 360. Alternatively, for example, if the IP address is associated with local portal 340, the network gateway 320 can provide the client devices 312 with access to the local portal 340.

### Network Destination Redirection

FIG. 4 presents a flow diagram for an example of a network destination redirection process 400. The process 400 can be implemented by any system that can direct or redirect a client device. For example, the process 400 can be implemented, in whole or in part, by the network gateway 220, the DNS server 270, the network system 290, the network controller 299, or the network gateway 320. In one embodiment, the process 400 advantageously enables an organization associated with the local computing environment 211 to provide a user 202 with a set of pre-defined services associated with the local portal 240. As another advantage, in one embodiment, the process 400 enables an organization to automatically provide personalized information to the user 202 based on a location of the user 202 or the client devices 212 associated with the user 202. Although, as described above, the network gateway 220 and the local computing environment 211 can be associated with any type of organization or entity, to simplify discussion, process 400 will be described assuming the network gateway 220 and the local computing environment 220 are associated with a hotel and that the user 202 is a hotel guest. Of course, the local computing environment 211 can include a geographic area or can include a group or chain of locations spread throughout a large geographic area. Although any number of systems, in whole or in part, can implement the process 400, to simplify discussion, the process 400 will be described as being generally implemented by the network gateway 220.

The process 400 begins at block 402 when, for example, the network gateway 220 receives a DNS query from the client devices 212 on behalf of a user 202. For example, a DNS query for room_service.<hotel_brand>.com or for mydetails.<hotel_brand>.com. This DNS query can be received from a browser or any other network application on the client devices 212. At decision block 404, the network gateway 220 determines whether the request includes a pre-defined DNS string. In some embodiments, the pre-defined DNS strings are defined by the network gateway 220 administrator. In other embodiments, the pre-defined DNS strings are predefined by some third-party organization or entity, such as the network gateway 220 manufacturer. In one embodiment, the pre-defined DNS strings match a pre-defined DNS query format.

Alternatively, the DNS strings can include any data value or identifier and are not limited by any pre-defined DNS query format. For example, the DNS string can include: food; 100.120.100.120; myaccount.<hotel_brand>.com; and #find_shopping, to name a few. This embodiment enables an administrator to define keywords that subscribers, such as the user 202, can use without regard to any DNS query format requirement. Further, in some embodiments, the keywords can include tags to facilitate identification of the keywords. For example, # or #find can be used as tags to indicate that keywords follow. Thus, in an embodiment, the pre-defined DNS strings may be identified by comparison with a list, by a prefix, by pattern matching, or by other means.

In one embodiment, the network gateway 220 sends the pre-defined DNS string to a DNS server 270 to determine if the DNS string is associated with the content site 260. If it is, in one embodiment, the network gateway 220 can do one or more of: ignore the pre-defined DNS string; ask an administrator to re-define the DNS string; present the user 202 with a choice between accessing the content site 260 or a portal page on the local portal 240 associated with the pre-defined DNS string; or automatically redirect the user 202 to the local portal 240.

If the DNS query does not include a pre-defined DNS string, the network gateway 220 forwards the DNS query to the DNS server 270 at block 414. If the DNS query does include a pre-defined DNS string, the network gateway 220 sends a DNS response that includes a “magic” IP address to the client devices 212 at block 406. As such, the network gateway 220 acts as a limited proxy that evaluates each DNS query before deciding whether to forward the DNS query to the DNS server 270. In an embodiment, at block 406, the network gateway may make a further determination as to which of several “magic” IP addresses to send, based on the received DNS string, server availability, load balancing, and/or other considerations. The network gateway may, in one embodiment, allocate a “magic” IP address from a block or group of addresses, and then store an association between the allocated address and the DNS query or other data (such as a unique identifier associated with the query). In one embodiment, the DNS response has a predefined time-to-live value, which indicates to the client device 202 that the association between the DNS string and the returned IP address should be cached or retained for a specific duration, thus advantageously causing the association to expire so that a different IP address may be provided at a later time.

In response to sending the DNS response to the client devices 212, the network gateway 220 receives an HTTP request from the client devices 212 associated with the “magic” IP address and the DNS query at block 408. In one embodiment, the HTTP request includes an HTTP Host header associated with a DNS query string. In this embodiment, the DNS query string associated with the HTTP Host header matches the pre-defined DNS string identified at block 404. However, in some embodiments, the DNS query string associated with the HTTP Host header may differ from the pre-defined DNS string identified at block 404. This difference may be intentional or the result of an error.

At block 410, the network gateway 220 determines whether the HTTP Host header associated with the HTTP request includes a pre-defined DNS string. This may involve determining whether the DNS query string associated with the HTTP Host header matches a pre-defined DNS string. If not, network gateway 220 returns an error response to the client devices 212 at block 416. The network gateway may additionally or alternatively use the IP address to which the HTTP request was directed and/or the IP address from which the request was received, in making this determination. For example, in the embodiment described above where the “magic” IP address is allocated and stored, the network gateway may determine the pre-defined DNS string associated with the HTTP request based on the stored association of that DNS string and the allocated IP address.

If the HTTP host header does include a pre-defined DNS string, the network gateway 220 sends an HTTP redirection response to the client devices 212 that includes a portal URL associated with the pre-defined DNS string and a set of redirection parameters at block 412. Generally, the redirection parameters are subscriber specific parameters. For example, the redirection parameters can include the user 202's room number, the MAC address associated with the client devices 212, or a unique user-specific value associated with the user 202. In one embodiment, the redirection parameters can be associated with multiple subscribers. For example, the redirection parameters can be associated with a family staying in one or more hotel rooms. The redirection parameter values can be obtained from one or more sources. For example, the redirection parameter values can be determined by the network gateway 220, obtained from the user 202, or obtained by accessing a data repository (not shown) associated with the local computing environment 211.

In one embodiment, the portal URL is associated with the local portal 240. Alternatively, the portal URL can be associated with the content site 260. This embodiment enables the hotel to contract with an outside provider that maintains its services off-site.

In one embodiment, the local portal 240 is associated with multiple pre-defined DNS strings. In this embodiment, multiple portal URLs can be associated with the local portal 240 enabling access to different services hosted by the local portal 240. Further, the network gateway 220 can provide different portal URLs for the pre-defined DNS string based on pre-defined additional factors. For example, the network gateway 220 can provide a different portal URL based on the traffic load of the local portal 240, the time of day, a pre-specified event (e.g. declination of a credit card associated with the user 202), or expiration of a pre-paid time period, to name a few.

In one embodiment, the client devices 212 can then follow the HTTP redirection response to access the local portal 240 via the local network 230. In this embodiment, the redirection parameter values are passed to the local portal 240 when the client devices 212 follow the HTTP redirection response. This enables the local portal 240 to obtain information specific to the user 202 associated with the client devices 212. Thus, in the mydetails.<hotel_brand>.com example, if the redirection parameter values include, inter alia, the user's 202 room number, the local portal 240 can cause the user's 202 bill or hotel stay itinerary to be presented to the user 202. Alternatively, in the room_service.<hotel_brand>.com example, based on the redirection parameters associated with the user 202, the local portal 240 can cause menus from a local food delivery service to be presented to the user 202 and can pre-populate the delivery and billing information for the user 202.

In an alternative embodiment, the client devices 212 can access the local portal 240 via the network gateway 220.

In one embodiment, after determining at block 404 that the DNS query includes a pre-defined DNS string, the network gateway 220 can provide the client devices 212 with the portal URL enabling the client devices 212 to access the local portal 240. In this embodiment, the local portal 240 can then query the network gateway 220 for any necessary parameter values associated with the user 202 and/or the client devices 212.

In one embodiment, the client devices 212 are configured to communicate with a proxy server. In this embodiment, when the network gateway 220 receives the DNS query, it can determine if the client devices 212 is attempting to communicate with a proxy server. If so, the network gateway 220 can mimic the proxy server.

Although described using the HTTP networking protocol, those skilled in the art will recognize, from the present disclosure, that the process 400 can be used with any other networking or communications protocol that facilitates the client devices 212 locating and accessing local portal 240 with the assistance of network gateway 220. For example, in some embodiments, HTTPS, S-HTTP, FTP, or SFTP, to name a few, can be used with process 400. In some embodiments, the use of alternate protocols may require user authentication. In these embodiments, the user 202 can be required to provide authentication. Alternatively, in some embodiments, the network gateway 220 can automatically authenticate the user 202 with the local portal 240 via the redirection parameters.

In an alternative embodiment, a DNS server 270 can perform, at least in part, the DNS-triggered redirection of HTTP request. For example, the DNS server 270 can receive the DNS query from the client device 212. The DNS server 270 can determine if the DNS query identifies a DNS associated with the network gateway 220. If the DNS server 270 determines that the DNS query identifies a DNS associated with the network gateway 220, the DNS server 270 can cause the client device 212 to receive a DNS response that includes an IP address associated with the network gateway 220. The client device 212 can create an HTTP request using the IP address received from the DNS server 270. In response to the network gateway 220 receiving the HTTP request from the client device 212, the network gateway 220 can then redirect the client device 212 to the local portal 240.

As previously mentioned, the process 400 can also be performed, in whole or in part, by the network controller 299 or the network system 290. Further, process 400 can be performed in a distributed manner by multiple systems. For example, as part of a distributed environment, process 400 can be performed in part by the network gateway 220, the network controller 299, and the DNS server 270.

In some embodiments, multiple local computing environments can use one or more network systems associated with the local computing environment 211, the local computing environment 231, and/or the external computing environment 221 to perform the process 400. Advantageously, in some embodiments, by enabling multiple local computing environments to use the network system 290 to perform the process 400, multiple organizations, franchisees of an organization, or locations of an organization can share use of the network system 290 for performing the process 400. For example, multiple locations of a hotel can use a single network system 290 to perform the network direction or redirection.

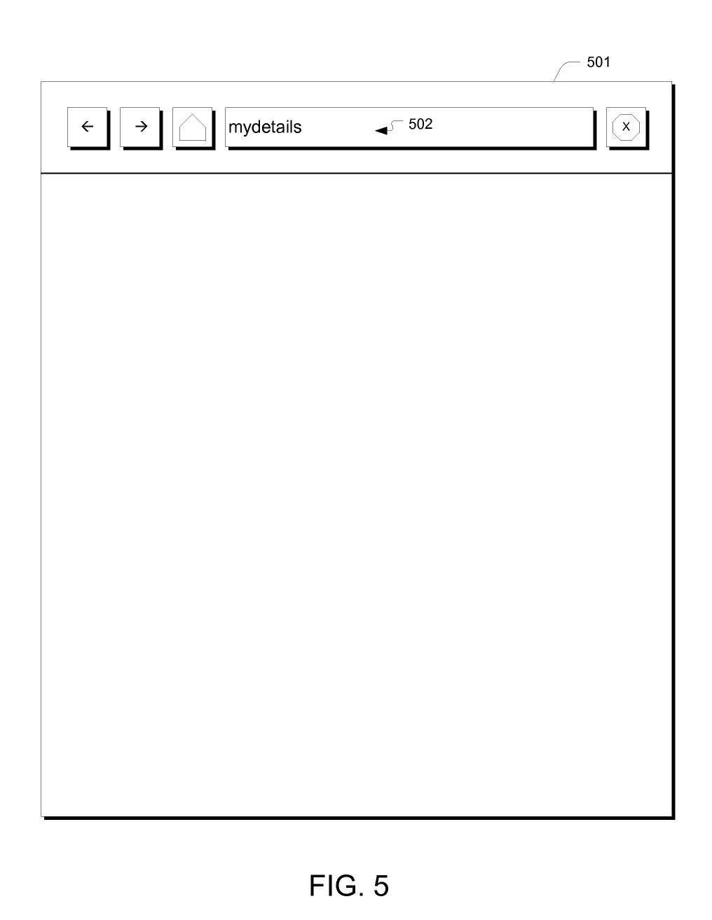

An embodiment of a web browser is shown in FIG. 5. Client devices 312 may operate such a web browser, or other software, to access the Internet and/or other networks.

Web browser window 501 includes an address bar 502. Various web browsers may provide different mechanisms for entering URLs or addresses to be accessed. For example, addresses may be provided by a user entering an address into a popup window, a user clicking on a link, an automated script or program operating, or the like.

The address bar 502 has a URL “mydetails” entered. In this embodiment, the word “mydetails” is a predefined string, as described previously with regard to FIGS. 1 and 4. The user may enter the URL with or without the “http://” prefix, and with or without a suffix such as “<hotel_brand>.com” depending on the configuration of the browser and the network.

By entering the URL into the address bar and/or by other means, the user may instruct the web browser to access the provided URL. In an embodiment, the web browser is caused to perform two network requests, namely a DNS request and an HTTP request. In various embodiments, the browser may issue additional requests or fewer requests.

In an embodiment, the web browser attempts to resolve the domain name of the URL, via a DNS request. In the embodiment of FIG. 5, the domain name of the URL in address bar 502 is “mydetails” (or “mydetails.<hotel_brand>.com” depending on the browser and network configuration). The domain name request may be directed to a network gateway or other server.

In an embodiment, the browser receives a DNS response indicating an IP address to be associated with the domain name. The IP address may be a “magic” IP address as described herein, and it may be received from a network gateway, in accordance with a method such as that described in FIG. 4. The DNS response may alternately be a CNAME response identifying a second domain name, or other form of response. The DNS response may further include a time-to-live value and/or any other data that may be included in a DNS response.

In an embodiment, the web browser may have previously cached an association between the domain name and an IP address such as the “magic” IP address, or the web browser may have access to such a cached association. In such a case, the web browser may or may not initiate a DNS request.

In an embodiment, the web browser attempts to retrieve content based on the URL. The web browser may construct and send a request directed to a server associated with the URL. In an embodiment, the request is an HTTP request. The request may be directed to the “magic” IP address or another IP address, which may be selected based on the domain name of the URL. Alternately, the request may be directed to a proxy server, which may or may not be a gateway device. The request may include all of, or a part of, the URL. For example, if the request is an HTTP request, it may include only the path, query, and/or fragment of the URL. The request may further include an indication of the domain name, such as in a Host header of an HTTP request.

As described previously, a network gateway may receive the HTTP request, whether or not the request is directed to the network gateway, and the network gateway may respond to the request. In an embodiment, the network gateway may respond with a redirection message, such as an HTTP 300-type response, or a web page including a META refresh tag. The response may indicate a URL to be accessed, which may be different from the URL entered into address bar 502. The response may be sent, for example, at block 412 of FIG. 4. Alternately, the network gateway may respond with alternate content rather than redirecting the browser to that content. The browser may be automatically configured to automatically access the URL in the redirection message, by initiating a second HTTP request directed to the second URL.

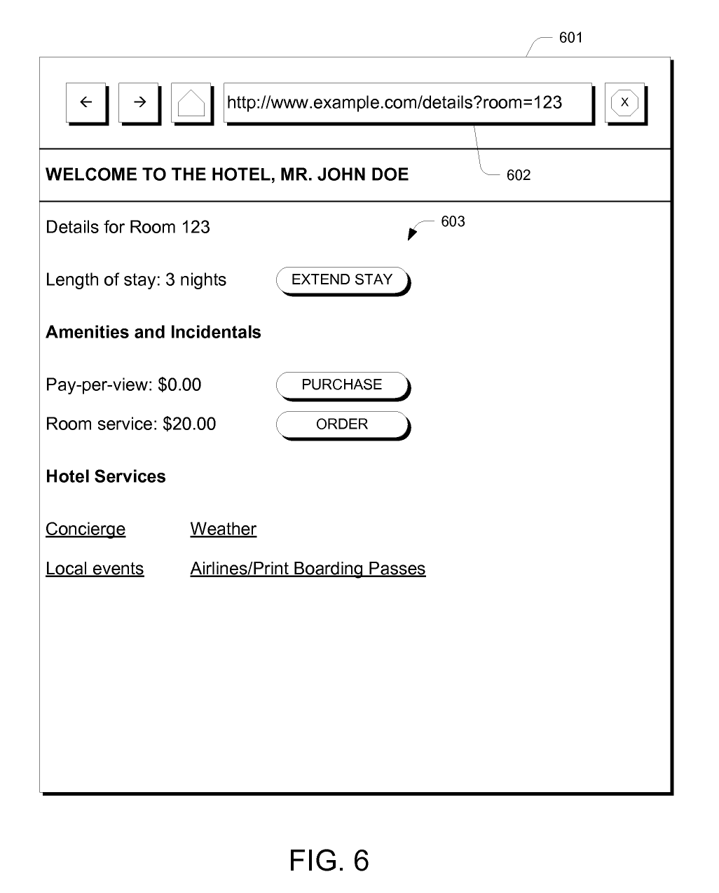

FIG. 6 depicts a web browser with a customized portal page, as used in an embodiment. The web browser window 601 may include an address bar 602 displaying a URL, which may be the second URL to which the browser was redirected as described above. The URL shown in address bar 602 may include a query string including a room number specific to the user of the browser, as determined by the gateway device or other sender of the second URL.

The contents of the web page displayed by web browser window 601 may include custom information and/or services for the user of the browser. For example, the web page may include information about the user's hotel stay and services and/or amenities provided by the hotel. It may further include options for ordering amenities and/or services. It may further include informational links or content. The particular information and/or services provided may depend on the string or keyword entered in the address bar. For example, the keyword “mydetails” was provided in address bar 502 of FIG. 5, so information about the user's account was provided in browser window 601 subsequenty. If the keyword “logout” had been entered, then the network gateway may have logged out of the user's account and displayed an indication that the logout had been successful. Other keywords may have other effects and/or provide different content, as configured on the network gateway.

Depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method of providing access to network services, the method being performed at a network gateway system connected to a user computer, the method comprising:
receiving, from a user computer, a request for resolution of a domain name, the request being based on a keyword command entered into the address bar of a web browser of the user computer;
transmitting, to the user computer, a domain name resolution response comprising a predefined IP address, based on a determination that the request for resolution included the keyword command;
receiving, from the user computer, an HTTP request directed to the predefined IP address;
determining, based on the HTTP request, the keyword command and the identity of a user of the user computer; and
responding to the HTTP request with a redirection message directing the user computer to a service URL, the service URL being selected based on the keyword command, the service URL being customized with parameters specific to the determined identity of the user.

2. The method of claim 1, wherein determining the keyword command comprises identifying a Host header of the HTTP request and determining that the Host header corresponds to the keyword command.

3. The method of claim 1, wherein the service URL identifies a web page with information associated with the determined identity of the user.

4. The method of claim 1, wherein the service URL is selected based, at least in part, on one or more of the keyword command, a time, and a predefined event.

5. The method of claim 1, wherein the predefined IP address is associated with a device in the network gateway system.

6. The method of claim 1, further comprising:
receiving an HTTP request for the service URL; and
transmitting a local portal page to the user computer, the local portal page being customized based at least in part on the parameters of the service URL specific to the identity of the user.

7. The method of claim 1, wherein the domain name resolution response further comprises a time-to-live value.

8. The method of claim 1, wherein the redirection message comprises one or more direction parameters associated with one or more of the following: the client device, the user, a second user associated with the user computer, and the service URL.

9. The method of claim 7, further comprising accessing the one or more direction parameters from one or more of a data repository, the user computer, the user, and the service URL.

10. A system for performing network gateway redirection, the system comprising:
one or more computer processors;
a network communications port in communication with the one or more computer processors;
a domain name resolution module configured to receive, via the network communications port, a request for resolution of a domain name, the domain name resolution module configured to determine that the domain name to be resolved is a predefined keyword, the domain name resolution module further configured to respond to the request for resolution with a predefined IP address, based on the determination that the domain name to be resolved is a predefined keyword;
an HTTP response module configured to receive, via the network communications port, an HTTP request directed to the predefined IP address, the HTTP response module further configured to determine, based on the HTTP request, the predefined keyword and a sender of the HTTP request, the HTTP response module further configured to respond to the HTTP request with a message identifying a service URL associated with the predefined keyword, the service URL further being customized with parameters specific to the sender of the HTTP request.

11. The system of claim 10, wherein the message identifying the service URL is configured to redirect a recipient of the message to a portal page on a local portal.

12. The system of claim 11, wherein the portal page comprises information associated with a user of the client device.

13. The system of claim 11, further configured to identify the portal page from a plurality of portal pages based, at least in part, on one or more of the pre-defined keyword, a time, and a pre-defined event.

14. The system of claim 10, further comprising a portal page module configured to receive a request identifying the service URL, the portal page module further configured to respond to the request with a portal page customized based at least in part on the parameters specific to the sender of the HTTP request.

15. The system of claim 10, wherein the domain name resolution module is further configured to respond to the request for resolution with a time-to-live value.

16. The system of claim 10, wherein the domain name resolution module is further configured to respond to the request for resolution with one or more redirection parameters.

17. The system of claim 16, wherein the one or more redirection parameters are associated with one or more of the following: the client device, a user of the client device, a second user associated with the user of the client device, and the local portal.

18. The system of claim 16, wherein the one or more redirection parameters are received from one or more of a data repository, the client device, a user of the client device, and the local portal.
